(19) United States
(12) Patent Application Publication
(10) Pub. No.: US 2003/0206997 A1
(43) Pub. Date: Nov. 6, 2003

(54) Susceptor sleeve for food products

(75) Inventors: Michael D. Winkelman, Victoria, MN (US); Stacey M. Lauen, Edina, MN (US)

Correspondence Address: MERCHANT & GOULD PC, P.O. BOX 2903, MINNEAPOLIS, MN, 55402-0903, US

(73) Assignee: Schwan's Sales Enterprises, Inc.

(21) Appl. No.: 10/137,853

(22) Filed: May 1, 2002

(51) Int. Cl. A23B 4/00

(52) U.S. Cl. 426/107

(57) ABSTRACT

A container for a food product having a filling is disclosed. The food container has an interior susceptor layer to facilitate microwave cooking of the food product. The container is collapsible to facilitate transport of the food product and container prior to consumption. The food envelope has a susceptor material along the entire interior surface, or along portions thereof. The envelope may be configured so as to completely enclose the food product. The container is configured to facilitate transport and consumption of the food product at sporting events, picnics, and the like.

### FIELD OF THE INVENTION

This invention relates to containers suitable for heating food items in a microwave oven, particularly food items that require surface browning and crisping, and containers that allow the food to be baked and/or reheated in the microwave for convenient consumption.

### BACKGROUND OF THE INVENTION

Microwave or conventional reheating of cooked frozen pizza saves time and expense. Frozen, single crust pizzas are typically prepared by the consumer in a conventional oven. Another type of pizza food involves a single portion dough wrapper placed around a filling such as sauce and cheese, which is sometimes called a pizza pouch or calzone. These products can be roughly semi-circular, cylindrical or rectangular and may be formed in “snack size” portions. Related products are known such as pop-tarts or toaster strudel products. These products tend to be roughly rectangular in shape and typically comprise a sweet dough with dessert-type filling such as fruits, custards, etc. Such conventional convenience foods have been well known for many years.

One disadvantage of these types of food is that they can be messy in many situations, such as at sporting events, picnics, in the car, etc. Another disadvantage is that these foods quickly cool after being heated, making it difficult for them to retain tastiness and appeal for a period of time after they are heated. Further, many microwaveable products, when cooked, are not crispy and/or lack a desirable golden brown color.

Even when a food is microwaved, it should be browned so as to closely resemble a food that has been cooked in a conventional oven. If no special provision is made for browning the exterior of the food, the exterior of the microwaved food may remain undercooked because of the surface cooking effect of the food as it is heated by microwave radiation.

There is a strong need for a food package that permits food to be heated and reheated in such a way that the food has a ready to eat configuration, which is easily handled and which does not drip or cause a mess. There is also a need for a food package that can be placed into a microwave oven to facilitate the uniform and efficient heating of the food product. The food package must be constructed such that sogginess in the cooked food product is avoided. A major problem with many microwaveable food packages is that moisture contained in the food product causes steam, and this steam must escape the product in order to avoid sogginess. In many closed packages, the steam cannot escape and the food may suffer from undesirable sogginess.

Many food products are difficult to prepare in a microwave oven, particularly those that require surface browning and crisping. In order to provide such browning and crisping, the use of packaging materials containing microwave susceptors has become popular. Such susceptors absorb microwave energy and as a result generate heat that is transferred to the food. Under favorable conditions, the susceptors transfer sufficient heat to the adjacent heat surfaces to create a browning and crisping effect.

Susceptor material may come in the form of a laminated sheet. However, in some cases, sheet material of this kind is stiff, brittle, subject to breakage, and not adapted for use in lightweight packaging products that are low cost and disposable. In other cases, the laminated susceptors, while interacting with the microwave energy present in an oven, do not adequately heat the food product. Still other laminates can heat only one side of the food product. So, for example, if the food product is rectangular in shape, two or more sides may remain unheated.

For microwave frozen products such as pizzas, it is known to provide a flat susceptor surface upon which the pizza is placed before it is positioned in the microwave for cooking. Another known device is a rectangular, paperboard sleeve having susceptor material on the entire inner surface of the sleeve. This sleeve is open on both of its ends, which has the advantage of easy insertion and withdrawal of the food, but which has the disadvantage of exposing the food product to possible contamination. This type of sleeve does not lend itself to easy and convenient portability, because of the risk that the food product will fall on the floor during its preparation or consumption.

### SUMMARY OF THE INVENTION

The invention is directed to a container for heating a food product and for optionally holding the food product during its consumption. The container has an envelope that can enclose and supportably contain the food. The envelope is sized and shaped to be capable of enclosing substantially all of the food product. The interior of the envelope has a susceptor surface to facilitate optional heating of the food product.

The container also includes enclosure means for protecting the food product from deformation. Because of the shifting of weight that occurs during transport, portions of the food product may be susceptible to damage or deformation. One type of enclosure means is a shrink-wrap film around the envelope and food item. Before the food item is shipped to its point of sale, the food item is positioned against the collapsed envelope, and the food and collapsed envelope are preferably surrounded by a film wrapping, with optional labeling. The film wrapping is preferably shrink-wrapped around the food and envelope. The collapsed container forms a support for the food, and the collapsed container extends past the outer edges of the food in order to protect the periphery of the food from damage. The edges and corners of the food are thereby protected from damage during manufacture, distribution and use.

In the preferred embodiment, multiple food products and containers are placed in a shipping carton for transporting the food items to their point of sale. In another preferred embodiment, an enclosure means comprises one or more walls within the shipping carton which are sized and shaped to minimize movement and shifting of the food items.

A preferred triangular form of the susceptor envelope can be used as a convenient container for certain types of food products. Other types of food products, such as round products, would be suitable for a U-shaped envelope. The consumer can use the envelope or sleeve to contain the food and permit it to cool gradually until the user is ready to eat it. The food is kept out of contact with the user and is protected from any contamination in the environment while the food is in the container envelope but the food is convenient to the consumer when needed.

The susceptor sleeve or envelope provides a number useful functions. First, the susceptor sleeve acts as a part of the packaging system. The susceptor sleeve is collapsible to a flat form, and the dimensions of the perimeter of the susceptor sleeve are larger than the dimensions of the perimeter of the food product of the invention. The susceptor sleeve thereby protects the food from damage during packaging, storage and transport. During heating of the food, the susceptor sleeve acts as a heat source during microwave cooking. In conventional thermal or convection invention cooking, the susceptor sleeve is not necessary.

After the food has been heated, the susceptor sleeve can be used as a handy container for the cooked food. During consumption of the food, the food item, or portions thereof, can be removed from the container. The food can be returned to the susceptor sleeve, acting as a convenient container, during the time the consumer retains an uneaten portion. The susceptor sleeve may be shaped and adapted for placement in coupler attachments often used in larger arenas, stadium or other venues in which pizza consumption is common. The container of the invention is intended to be disposable after the food has been eaten.

Other objects, advantages, and features of the present invention will become apparent from the following specification when taken in conjunction with the accompanying drawings.

### SUMMARY OF CLAIMS

The invention is a container for a food product, comprising an envelope or sleeve that is shaped and sized to be capable of containing the entire food product. The envelope is collapsible to a flat configuration, and at least a portion of the container's interior surface has a susceptor layer. The container has an openable first end for inserting and removing the food product, and an opposite second end that is substantially closed. The term “openable” as used herein is meant to include a structure having an open end. The container also includes enclosure means for protecting the edges and/or tips (if any) of the food products. One type of enclosure means is a film enclosure that is a shrink-wrapped polyolefin film. Another type of enclosure means is a carton having one or more walls that form individual compartments for the individual compartments for the individual food items.

The openable first end of the envelope may comprise an opening having no cover, or the openable end may have a lid, cover, or a set of flaps that allow the user to easily open and close the openable end of the container.

The food container may be triangular in shape, substantially U-shaped, or any other configuration allowing for one openable end, with the other portions of the container being closed so as to prevent the food product from falling out.

In certain embodiments of the invention, the susceptor material extends over the entire inner surface of the container. In other embodiments of the invention, the susceptor material extends over only a portion of the sleeve's interior surface, preferably a central portion that substantially overlays the filling within the food product.

### BRIEF DESCRIPTION OF THE DRAWINGS

FIG. 1 is a top plan view of a flat, unfolded container of the present invention;

FIG. 2 is a perspective view of the container of FIG. 1, with the food product therein;

FIG. 3 is a perspective view of the container of FIGS. 1-2 from a different angle;

FIG. 4 is a perspective view of a packaged pizza food using the container illustrated in FIGS. 1-3;

FIG. 5 is a perspective view of a second embodiment of the container of the present invention;

FIG. 6 is a top plan view of a third embodiment of the present invention;

FIG. 7 is a top plan view of a fourth embodiment of the present invention; and

FIG. 8 is a top plan view of a fifth embodiment of the present invention.

### DETAILED DESCRIPTION OF THE INVENTION

The package or container of the present invention is suitable for pizza, pocket sandwiches, pies, bakery products, turnovers, pot pies, puff pastries, French fried potatoes, fish sticks, egg rolls, bread sticks, waffle sticks, and other food products. The container permits the browning, crisping and/or toasting of the surface of these foods. With the present invention, individual portions of a food item are preferably packaged on top of a collapsed susceptor envelope and then shrink-wrapped in a clear film enclosure. The file enclosure may have an appropriate label and cooking instructions. Alternatively, the food item could be packaged inside the assembled, three-dimensional envelope before the assembly is shrink-wrapped.

The susceptor envelope is expandable from a flattened configuration to a three-dimensional configuration. This feature is caused by the presence of fold lines or pleats in the peripheral side walls of the envelope. The envelope is preferably triangular in shape. Alternatively, the carton may be substantially U-shaped, or have some other shape that corresponds with the shape and size of the food item. The carton encloses the entirety of the individual serving size portion of the food.

In the preferred embodiment, the food is pizza that is fully enrobed with crust on the top, bottom, and end sides. The pizza has a base crust substantially in the shape of an isosceles triangle, the surface area of the pizza being less than about 30 in². Upon the base crust, a filling is deposited, preferably in the shape of a complementary but smaller isosceles triangle and preferably about 20-120 grams of pizza filling.

When the consumer is ready to heat the food, the shrink-wrap film is removed from the susceptor envelope, the individual serving size pizza slice is placed within the susceptor envelope, and the envelope is placed into a microwave oven and cooked for a sufficient period of time to heat the food.

In one embodiment, the flattened susceptor envelope forms a triangular support layer that extends dimensionally past the edges or sides and apex of the triangular shaped pizza slice. The extended support layer protects the pizza slice from damage during the manufacturing, packaging, distribution, sale and reheating processes. The pizza and support layer are packaged within a film envelope. Conventional, typically transparent, translucent or opaque film packaging can be used with adhered labels or labeling information printed directly onto the film package.

In use, the pizza and susceptor envelope are removed from the film packaging, the pizza is placed in the susceptor envelope, and the envelope and pizza are placed in a microwave oven, wherein the microwaves' contact with the susceptor layer provides heat to produce a cooked pizza slice having a desirable temperature and crispiness.

Alternatively, a differently shaped susceptor envelope can be used. The envelope can be a substantially U-shaped envelope that can enclose a circular food product. The envelope can be a rectangular-shaped envelope that can enclose a rectangular food product, or that can enclose two triangular-shaped pizza slices or other type of food.

The preferred triangular envelope typically forms an interior shape that substantially conforms to the shape of a pizza slice. The envelope includes susceptor material on one, two or all surfaces of the interior of the envelope, which results in even cooking of the pizza slice. As such, the envelope is sized to be slightly larger than the pizza slice and conforms to dimensions that permit the pizza slice to be inserted into the susceptor envelope for cooking.

Before shipping of the food, the susceptor envelope is folded or compressed into a flat support layer that protects the food or pizza slice from damage. When the food is to be heated, the envelope is unfolded to a three-dimensional configuration and the pizza slice is inserted into the envelope so that the pizza slice comes in contact with the susceptor surface of the envelope. The pizza slice is then cooked using microwave technology to result in a fully cooked, crispy pizza slice. The susceptor material presents heat to all major surfaces of the food.

One advantage of the invention is the convenience of handling the container after cooking. The container can be transported from oven to table or to any other location where the food will be consumed, such as picnics, sporting events, school functions, in the car, or any other place where conventional knife and fork consumption of the food item may not be possible or convenient. The susceptor container of the invention permits ease of consumption of the pizza food with only one hand, but protects the pizza food from contamination in the environment when the consumer is not handling the food item. Further, the container permits the food to cool to a comfortable consumption temperature without undesirable contact between consumer and the hot item.

The preferred container has a triangular shape with accordion folds along the equal sides of the isosceles triangular-shaped container. The container can also have one or more vents to permit escape of cooking vapor and/or other openings throughout the container to permit viewing of the food during cooking and/or consumption. The container of the invention is typically cut from paperboard material containing a laminated susceptor layer. The envelope is then folded into a useful shape prior to the final packaging of the manufactured unit.

As will be seen from the five embodiments depicted, the envelope may be manufactured in a wide variety of sizes and shapes to conform with the food product. In addition, the container may be completely enclosed to enhance portability, and the susceptor material may be positioned on the container's interior surface(s) in such a way as to maximize cooking efficiency and enhance the cooking results.

### DETAILED DESCRIPTION OF THE DRAWINGS

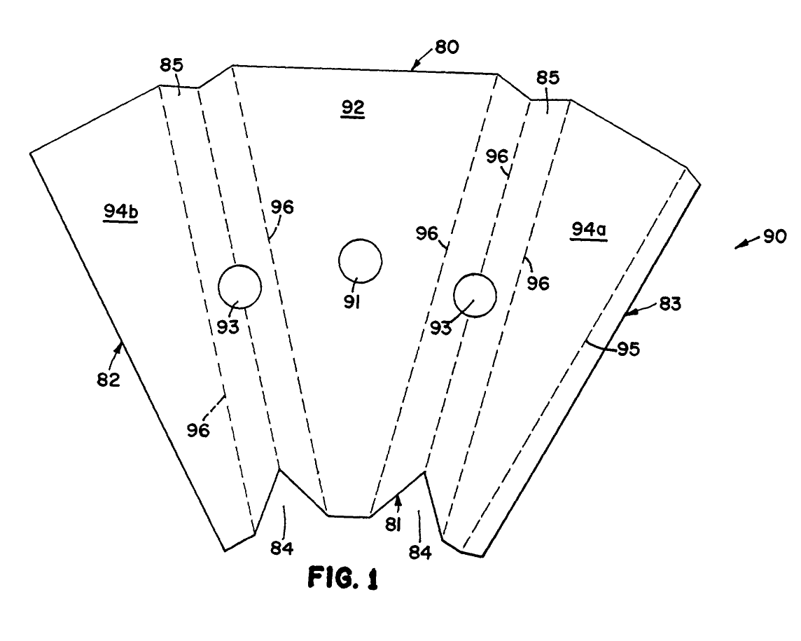

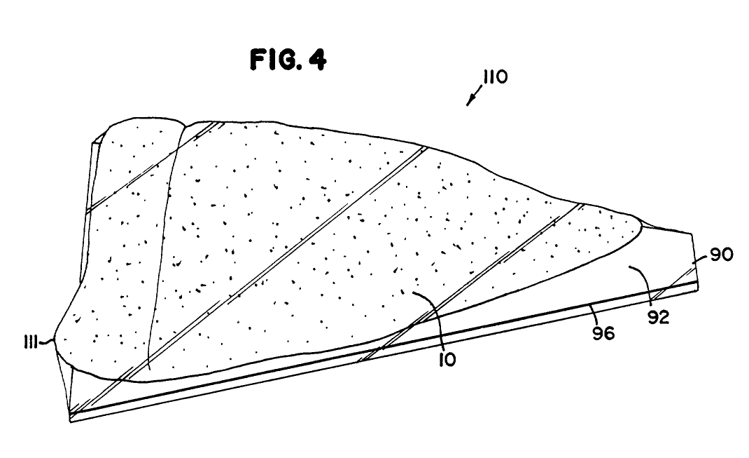

FIGS. 1 through 4 illustrate a preferred embodiment of the food package of the present invention. FIG. 1 is a drawing of the unfolded carton or envelope 90 in its blank form. The carton blank is constructed in suitable form and shape by using conventional cutting techniques and preformed material well known to those skilled in the art. The package 90 has one transverse edge 80 which is longer than the opposite transverse edge 81 and two longitudinal edges 82 and 83 having the same length as each other. The narrow carton edge 81 has a pair of notches 84. The carton 90 includes a substantially triangular top panel 92, bottom wall panels 94a and 94b, and two side panels 85. The panels 92, 94a and 94b are separated by fold lines 96. In the preferred embodiment, the fold lines are formed by partially cutting a series of longitudinal notches in the carton blank. These notches form the fold lines 96 that permit the envelope 90 to be formed into either a flattened configuration or a three-dimensional configuration. During the manufacture of the container, the blank is folded into an appropriate shape, and the longitudinal edge portion 95 is secured to the opposite edge 82 of the carton by means of a suitable adhesive. In this manner, the package's center unit 92 becomes the top wall of the container, and portions 94a and 94b are adhered along edge portion 95 to form the bottom wall of the container. The package 90 is then flattened by compressing the pleated accordion folds formed by fold lines 96. The food 10 is placed on top of the flattened package 90, after which the entire assembly is shrink-wrapped, as illustrated in FIG. 4.

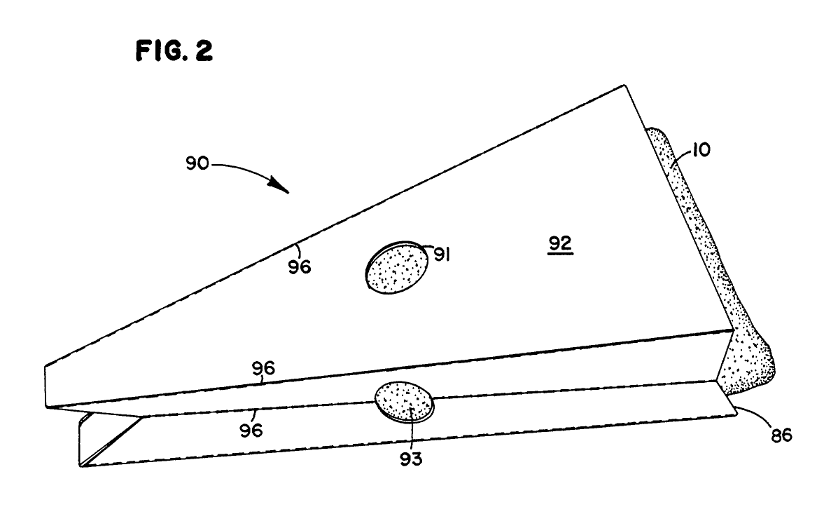

The susceptor carton 90 features a central vent 91 in the top panel 92 and two side vents 93 in the side panels 85. The vents are positioned near the center of the carton as shown in FIG. 2. These vents permit the escape of steam during cooking, and also permit the user to see the food product. The vents 91, 93 insure that moisture in the form of steam can escape from the food product 10 so that the food product comes out of the microwave oven crispy and not soggy.

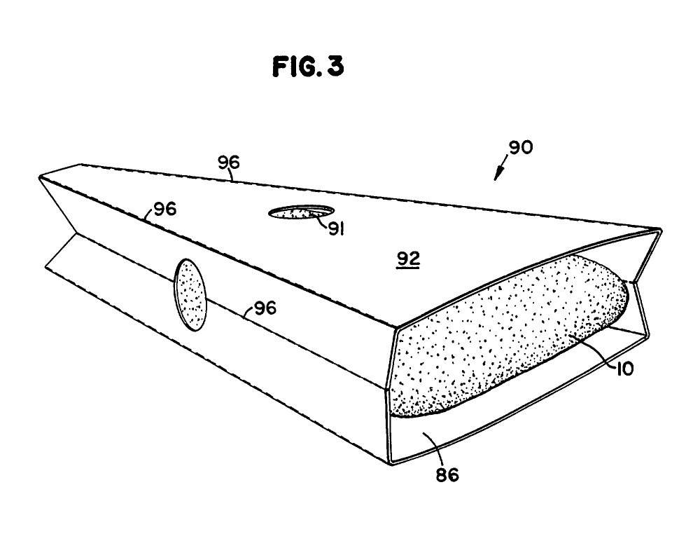

FIGS. 2 and 3 are representations of the container of FIG. 1 in an assembled form containing an individual serving size portion of the food 10. For purposes of illustration, the type of food is a slice of pizza 10 having a substantially triangular shape. The periphery of the susceptor container 90 is slightly greater in size than the product 10 to help protect the tips and crust lip of the product. (FIG. 2 shows the crust end of the pizza as being slightly outside the end of the container 90, but in use the entire pizza slice 10 would be entirely within the envelope 90.) An individual serving size pizza portion 10 is shown held within the carton 90 after the carton has been removed from the shrink wrap film and formed into a three-dimensional shape. It would be possible to design the container 90 and food product so that the container could hold more than one portion or individual pieces of the food product.

When in the three dimensional shape, the central panel 92 forms the top wall, the side panels 94a and 94b form the bottom wall, and the side panels 85 form the substantially vertical side walls. The apex of the food 10 is contained in the narrow end of the container 10 formed by the edge 81, and the notches 84 form a small opening at the apex end of the pizza. As shown, the apex end of the container 90 is substantially closed. The opposite end of the pizza 10 is partially exposed by the opening or openable end 86 in the container 90, as shown in FIG. 3. When the consumer holds the pizza 10 in the container 90 such that the apex end is lower than the openable end 86 of the container 90, it is not possible for the pizza 10 to fall out of the container 90.

FIG. 4 illustrates the packaged pizza assembly 110. The shrink wrap film 111 surrounds both the pizza 10 and flattened envelope 90. Typical film packaging can include films made from commonly available polymeric materials including polyolefins such as polyethylene and polypropylene, polystyrene, polyester, polyvinylchloride and other commercially available film materials. Single or multilayer films can be used to obtain protection from the permeation of undesirable materials from the exterior to the interior of the package and to prevent moisture from leaving the package, resulting in a dry, undesirable product. Also, the film 111 prevents loss of flavor. The enclosure means or film 111 is preferably shrink-wrapped into place. Alternatively, the enclosure film 111 can be closed using compression technology, adhesive technology or thermal technology for sealing the seams and edges of the film 111.

The envelope 90 is made of a food grade paperboard or other suitable stock material. The paperboard is preferably formed of a low-density material having relatively high insulating capacity and a heat stability sufficient to withstand cooking temperatures in a microwave oven. Suitable materials for use as this stock material are papers, glassine materials, plastics, ceramics and various coated papers. Preferred materials for use in disposable containers include paperboard, coated paper and other paper combinations conventionally used for cartons and packages.

In the preferred embodiment, the entire interior surface of the paperboard envelope is coated with a thin layer of susceptor material that has been applied to a protective film. In the preferred embodiment, the susceptor film is laminated to the paperboard.

Preferably, the susceptor material is applied to a protective film substrate by a vacuum deposition technique or by any other technique that provides a substantially continuous layer of susceptor material of the desired thickness. The susceptor material can be in the form of a coating of about 5 to 80% by weight of metal or metal alloy in flake form. A thin coating thickness of about 0.01 mm to about 0.25 mm (about 0.4 to 10 mils) is suitable for many applications. In the preferred embodiment, for the metal aluminum, the desired thickness corresponds to a surface resistance of between 0.4 and 8 ohms per square inch or a thickness of between 200 and 300 angstroms. The amount of susceptor material may be varied within certain limits that will be apparent to one skilled in the art. The test to determine the correct amount of material is whether the susceptor coating will heat to the proper temperature and provide sufficient heat for browning or crisping of food items. The required temperature may depend on the particular food item, but for many applications is at least about 400 degrees F.

The protective film layer ensures that the food does not have direct contact with either the susceptor material or the paperboard layer. Suitable materials for use in constructing the protective film layer include polyesters, polyethylene, nylon, cellophane, polysulphone and other relatively stable plastic substances. Polyester is a particularly well suited material for use as the protective layer in view of its high heat stability and its surface smoothness. The susceptor material is preferably deposited on the surface of the protective layer before such layer is bonded to the paperboard layer. Aluminum coated on polyester, available commercially, is the preferred susceptor material for the present invention. As stated above, this susceptor material is then laminated to the paperboard stock.

Suitable susceptor flake materials for use in the susceptor layer include aluminum, nickel, antimony, copper, molybdenum, iron, chromium, tin, zinc, silver, gold, and various alloys of these metals. In the preferred embodiment, the susceptor material is aluminum.

When the container 90 and food 10 are placed in the microwave oven and subjected to microwave radiation, the susceptor layer rapidly heats to a relatively high temperature. The heat generated by the metal susceptor layer acts to brown the surface of the food 10. This construction also allows the food product 10 to stay warm for a significant period of time after being heated in the microwave oven.

The container 90 may be constructed in any desired geometry or shape depending upon the shape and configuration of the food. The container is designed so as to be disposable and is therefore constructed of economical, commercially available components. The invention can be adapted to any such food product having a triangular, circular, oval, rectangular, cylindrical, or square shape.

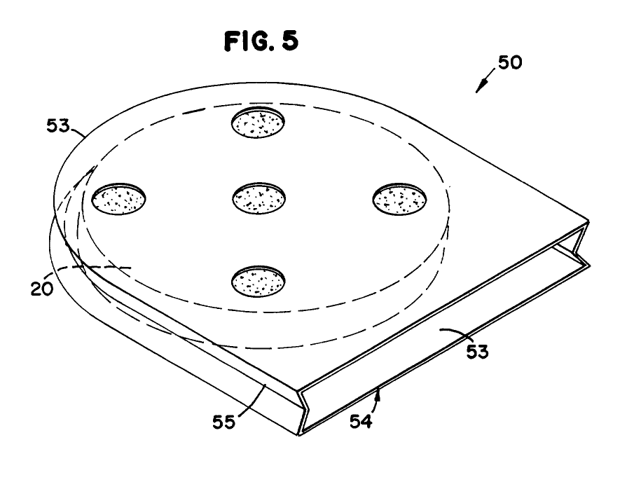

An alternative embodiment 50 of the carton is illustrated in FIG. 5. This embodiment is substantially U-shaped, having one end 52 that is closed and arcuate and an opposite end 53 that has a straight edge 54. The end 53 has an opening for insertion and removal of the food product 20. The edges of the container 50 have an accordion fold construction similar to the first embodiment, with a continuous fold line 55. The food 20 contained within the carton 50 is substantially circular in shape. The openable end 53 of the carton 50 can be either completely open, as shown, or can have a foldable flap, cover, or lid (not shown) for providing complete protection to the food product 20. The interior surface of the carton 50 has either a continuous or partial coating of susceptor material.

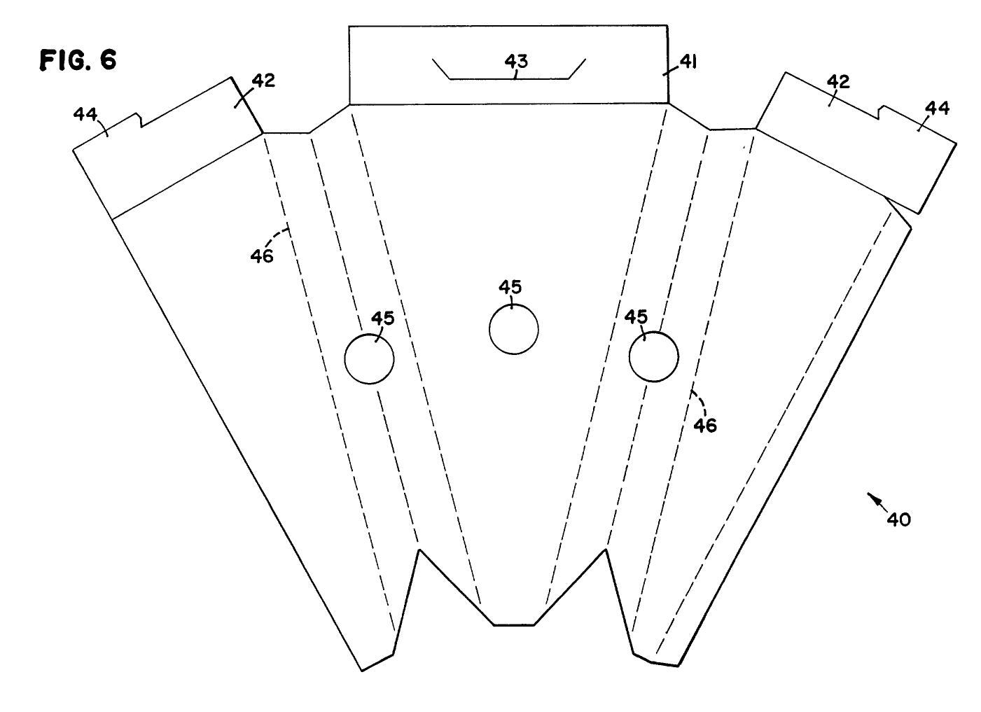

FIG. 6 illustrates the blank for a third embodiment 40 of the invention. The carton 40 is identical to the design of the carton 90 illustrated in FIG. 1, with vent holes 45 and fold lines 46. The openable end of the carton 40 has a central flap 41 and two side flaps 42. The central flap 41 has a slit 43, and each side flap 42 has a tab 44. When the carton 40 is assembled into its three-dimensional, substantially triangular configuration, the tabs 44 are inserted into the slit 43 to form a closed back wall along the crust edge of the food. This provides protection from contamination, ease of handling, and additional heat insulation for the warm food product. The closeable feature of the carton 40 allows the food to be transported somewhere before consumption, as when the food will be consumed in an informal setting such as a sporting event, picnic, festival, etc.

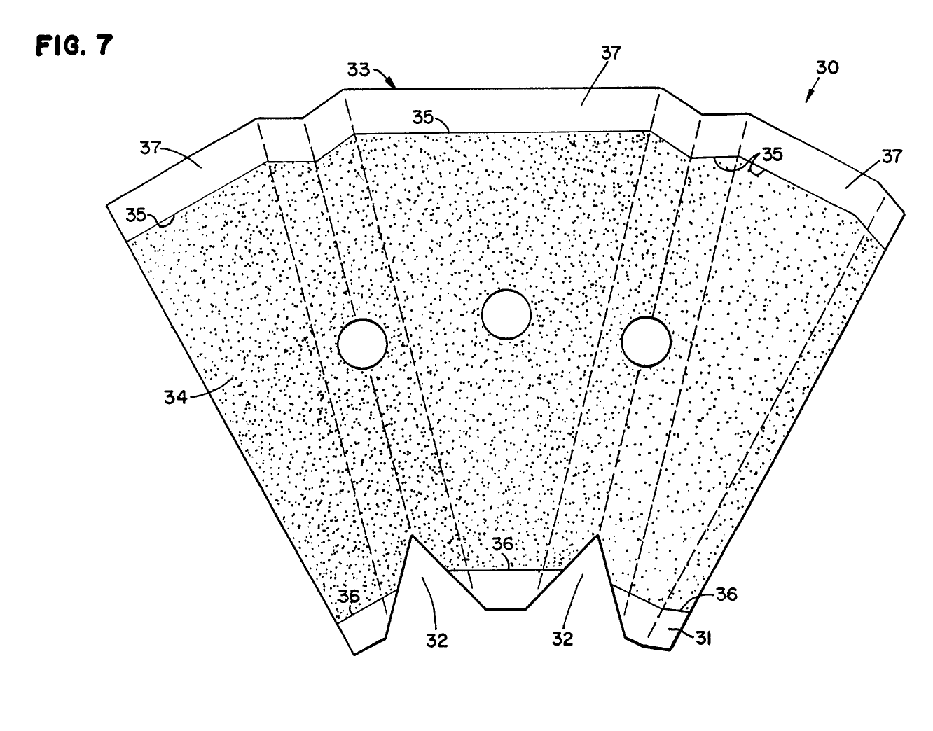

FIG. 7 illustrates the blank for an alternative carton 30. The carton 30 has an openable end 33 and an apex end 31 having notches 32. The apex end 31 is substantially closed when the carton is formed into its three-dimensional configuration. A substantial portion of the interior surface of the carton 30 has susceptor material 34 applied thereto. The susceptor surface is illustrated by the dots. However, the tip edge 31 of the carton 30 and the crust edge 37 of the carton 30 have no susceptor material thereon. The approximate placement of the line delineating the boundary of the susceptor material is illustrated by lines 35, 36. This design provides protection for the tip and crust lip of the pizza or food product, and prevents these areas from being overcooked because of the absence of susceptor material at those points. The susceptor material's placement in FIG. 7 substantially corresponds to the location of the filling within the food product (not shown). In this manner, the microwave energy is concentrated on the filling portion, and this design enhances the ability to cook the food quickly.

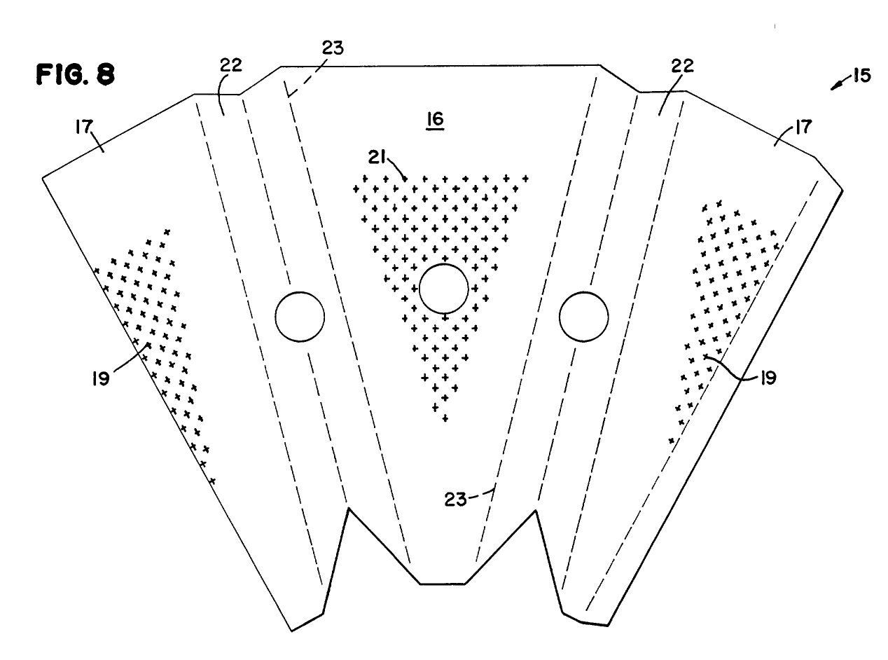

FIG. 8 illustrates the blank for another alternative carton 15. The carton 15 has a central panel 16 and two opposing wings 17 that form the bottom panel 17 when the envelope 15 is constructed. The envelope has side panels 22 with fold lines 23. The carton 15 is similar in construction to the embodiment of FIG. 7, with susceptor material 19 being applied to a portion of the interior surface of the paperboard envelope 15. However, in the embodiment of FIG. 8, the susceptor material is applied in a patterned manner on the central panel 16 and the side panels 17. This forms a triangular susceptor pattern 21 on the top panel 16 and an opposite triangular susceptor pattern on the bottom panel 17. With this embodiment, the susceptor material 18 is applied in a “sputtered” or patterned manner so that the central portion of the top and bottom walls of the carton 15 have relatively more susceptor material than other portions of the carton 15. The white portions of the carton 15 are the portions which preferably have no susceptor material in this embodiment, in order to enhance the cooking of the food product and prevent undesirable overcooking.

The above discussion, information, disclosure and exemplary embodiments provide a basis for understanding the metes and bounds of the invention and disclose several preferred embodiments. However, since many embodiments of the invention can be made without departing from the spirit and scope of the invention, the invention resides in the claims hereinafter appended.

We claim:

1. A container for a food product, said container having a first end, a second end opposite the first end, and at least one side wall, said container comprising:
(a) an envelope having a plurality of interior surfaces, said envelope being conformed to a size and shape capable of enclosing substantially all of the food product, the side wall of said envelope having fold lines so that said envelope is collapsible to a flat configuration, wherein an interior surface of said envelope has a susceptor material, said envelope having at least one vent; and wherein the first end of said envelope is openable and the second end is substantially closed, and wherein the first end of said envelope is larger than the second end of said envelope; and
(b) enclosure means in contact with the food product.

2. The container of claim 1, wherein said enclosure means comprises a shrink-wrapped film surrounding said envelope and the food product.

3. The container of claim 1, wherein said container is positioned within a carton, and said enclosure means comprising a carton wall.

4. The container of claim 1, wherein said envelope has multiple interior surfaces, wherein said susceptor material continually extends on all interior surfaces of said envelope.

5. The container of claim 1, wherein said envelope has a substantially triangular configuration, said first end being substantially closed.

6. The container of claim 5, wherein the second end of said envelope is open.

7. The container of claim 5, wherein the second end of said envelope has at least one closeable flap.

8. The container of claim 2, wherein said susceptor material extends on a portion of the interior surfaces of said envelope.

9. The container of claim 8, wherein said envelope has a top wall and a bottom wall, wherein said susceptor material extends on a central portion of said top wall and said bottom wall.

10. The container of claim 9, wherein the food product has a filling, said susceptor material extending on an interior surface substantially corresponding to the filling.

11. The container of claim 1, wherein the food product has a filling, said susceptor material extending on an interior surface substantially corresponding to the filling.

12. The container of claim 1, wherein said envelope has a substantially U-shaped configuration.

13. A triangular shaped food container having a susceptor layer on all interior surfaces, the container comprising at least one layer comprising substantially cellulosic paperboard having an interior surface and an exterior surface, the paperboard having preformed fold lines that permit folding the container from of a flattened triangular configuration to an expandable interior volume that is shaped to contain a triangular shaped baked food item.

14. The container of claim 13, wherein the container comprises at least one vent that can permit the release of cooking vapors.

15. The container of claim 13, wherein the susceptor layer is formed on the entirety of the interior surface.

16. The container of claim 13, wherein the paperboard has a first and a second longitudinal edge, wherein the container is formed by adhering the first edge of the paperboard to the second edge of the paperboard.

17. The container of claim 13, wherein the container comprises a first triangular side, a second triangular side and positioned therebetween a first pleated side and a second pleated side, the separation between the first side and second side comprising less than about one inch measured when expanded to the maximum interior volume.

18. The container of claim 13, wherein the susceptor layer extends on a portion of the interior surface.

19. The container of claim 18, wherein the food container contains a food product having a filling, the susceptor layer extending on an interior surface corresponding to the filling.

20. The container of claim 19, wherein the susceptor layer extends on two opposite interior surfaces corresponding to the filling.

21. The container of claim 13, wherein the food container has an apex end and a wide end, the wide end of the food container being closeable.

22. A container for a triangular pizza product, said container having an apex end and an opposite crust end, said container comprising:
(a) an envelope having a plurality of interior surfaces, said envelope having dimensions slightly larger than the dimensions of the pizza product, said envelope having fold lines so as to be collapsible to a flat configuration, wherein all of the interior surfaces have a susceptor layer, said envelope having at least one vent, wherein said apex end is substantially closed and said crust end is openable; and
(b) a film enclosure comprising a shrink-wrapped polyolefin film.
